(19) United States
(12) Patent Application Publication
(10) Pub. No.: US 2018/0239022 A1
(43) Pub. Date: Aug. 23, 2018

(54) DISTANCE MEASURING DEVICE AND DISTANCE MEASURING METHOD

(71) Applicant: MSI Computer (Shenzhen) Co., Ltd, Guangdong Province (CN)

(72) Inventors: Yung-Shen Lee, Taipei City (TW); Yao-Shih Leng, Taipei City (TW)

(73) Assignee: MSI Computer (Shenzhen) Co., Ltd, Guangdong Province (CN)

(21) Appl. No.: 15/499,885

(22) Filed: Apr. 27, 2017

(30) Foreign Application Priority Data
Feb. 22, 2017 (TW) 106202562

(51) Int. Cl. G01S 17/93; G01S 7/481

(52) U.S. Cl. CPC G01S 17/936; G01S 7/4817

(57) ABSTRACT

A distance measuring device and a distance measuring method are provided. The distance measuring device includes a vehicle, a scanning unit and a processing unit. The scanning unit includes a light-emitting unit and a light-receiving unit. The scanning unit and the processing unit are disposed on the vehicle. The processing unit is electronically coupled to the scanning unit. The vehicle is configured to move on a plane. The light-emitting unit is configured to emit a light beam along an emission direction, wherein the emission direction of the light beam is not parallel to the plane. The light-receiving unit is configured to receive a reflective light of the light beam reflected by an object. The processing unit is configured to determine a distance between the vehicle and the object according to the reflective light.

### CROSS-REFERENCE TO RELATED APPLICATION

This application claims the priority benefit of Taiwan application serial no. 106202562, filed on Feb. 22, 2017. The entirety of the above-mentioned patent application is hereby incorporated by reference herein and made a part of this specification.

### BACKGROUND OF THE INVENTION

### 1. Field of the Invention

The invention relates to a distance measuring device for detecting obstacle.

### 2. Description of Related Art

With advancements in technology, cleaning robots (e.g., vacuuming robots, sweeping robots or mopping robots) have been extensively applied in daily life for cleaning operations. In general, because the cleaning robots are usually unmanned equipments, the cleaning robots are disposed with a scanning unit for detecting obstacle. With operation of the scanning unit, the cleaning robots are able to effective go around avoiding obstacle during cleaning operations within a space.

FIG. 1A and FIG. 1B are schematic diagrams of a conventional cleaning robot. With reference to FIG. 1A, it is assumed that a cleaning robot 100 performs cleaning operations by moving on a plane S1. In conventional art, the cleaning robot 100 is disposed with a scanning unit 10 for detecting an obstacle within the space. In general, the scanning unit 10 emits a light beam L1 along an emission direction in parallel to the plane S1. Then, the scanning unit 10 can receive a reflective light of the light beam L1 reflected by the obstacle. By doing so, the cleaning robot 100 is able to determine whether the obstacle is at the front according to the reflective light.

Taking a chair 200 as an example of the obstacle, in FIG. 1A, because the light beam L1 can pass through under the chair 200, the cleaning robot 100 determines that it is feasible to continue moving forward for passing through under the chair 200. However, it should be noted that, as restricted by hardware architecture of the scanning unit 10, a height h1 from the plane S1 to the top of the scanning unit 10 is usually higher than a height h2 from the plane S1 to the light beam L1. With reference to FIG. 1B subsequent to FIG. 1A, since the light beam L1 can pass through under the chair 200, the cleaning robot 100 continues to move towards a lower side of the chair 200 so as to clean the plane S1 beneath the chair 200. Assuming the bottom of a cushion of the chair 200 is located between the height h1 and the height h2, when the cleaning robot 100 reaches the lower side of the chair 200, the scanning unit 10 of the cleaning robot 100 will collide with the chair 200 (at a position 300 in FIG. 1B).

That is to say, in conventional art, the cleaning robot 100 is only able to detect the obstacle on the plane S1 in parallel to the emission direction according to the light beam L1 but unable to detect obstacles at locations in a vertical direction of the plane S1 with the height higher than the height h2 from the plane S1 to the light beam L1 according to the light beam L1.

### SUMMARY OF THE INVENTION

The invention is directed to a distance measuring device and a distance measuring method, which can effectively detect the obstacle and prevent the distance measuring device from collusion with the obstacle by adjusting the emission direction of the light beam emitted by the scanning unit.

The invention provides a distance measuring device. The distance measuring device has a vehicle, a scanning unit and a processing unit. The scanning unit includes a light-emitting unit and a light-receiving unit. The scanning unit and the processing unit are disposed on the vehicle. The processing unit is electronically coupled to the scanning unit. The vehicle is configured to move on a plane. The light-emitting unit is configured to emit a light beam along an emission direction, wherein the emission direction of the light beam is not parallel to the plane. The light-receiving unit is configured to receive a reflective light of the light beam reflected by an object. The processing unit is configured to determine a distance between the vehicle and the object according to the reflective light.

In an embodiment of the invention, an acute angle included by the plane and the emission direction is greater than 0° and less than 90°.

In an embodiment of the invention, the acute angle included by the plane and the emission direction is 1°.

In an embodiment of the invention, the processing unit is further configured to determine a vertical height between a reflective spot on the object and the plane according to the reflective light. The light beam is reflected at the reflective spot to generate the reflective light.

In an embodiment of the invention, the processing unit is further configured to send a control signal for adjusting an angle of the acute angle included by the plane and the emission direction.

In an embodiment of the invention, the scanning unit is configured to rotate along a normal line of the plane.

The invention also provides a distance measuring method for a distance measuring device. The distance measuring device has a vehicle, a scanning unit and a processing unit. The scanning unit includes a light-emitting unit and a light-receiving unit. The scanning unit and the processing unit are disposed on the vehicle. The processing unit is electronically coupled to the scanning unit. The vehicle is configured to move on a plane, and the distance measuring method includes: emitting a light beam along an emission direction by the light-emitting unit, wherein the emission direction of the light beam is not parallel to the plane; receiving a reflective light of the light beam reflected by an object by the light-receiving unit; and determining a distance between the vehicle and the object according to the reflective light by the processing unit.

In an embodiment of the invention, an acute angle included by the plane and the emission direction is greater than 0° and less than 90°.

In an embodiment of the invention, the acute angle included by the plane and the emission direction is 1°.

In an embodiment of the invention, the method further includes: determining a vertical height between a reflective spot on the object and the plane according to the reflective light by the processing unit, wherein the light beam is reflected at the reflective spot to generate the reflective light.

In an embodiment of the invention, the method further includes: sending a control signal by the processing unit to adjust an angle of the acute angle included by the plane and the emission direction.

In an embodiment of the invention, the method further includes: rotating the scanning unit along a normal line of the plane.

Based on the above, by adjusting the emission direction of the light beam emitted by the scanning unit, the distance measuring device of the invention can effectively detect the obstacle and prevent the distance measuring device from collusion with the obstacle. In particular, instead of using a three-dimensional scanning unit in high price, the distance measuring device of the invention can scan the vertical height of the obstacle within the space by using common scanning units in low price, so as to achieve the similar effect of the three-dimensional scanning unit for detecting the height of the obstacle.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are schematic diagrams of a conventional cleaning robot.

FIG. 2 is a block diagram illustrating a distance measuring device according to an embodiment of the invention.

FIG. 3 is a schematic diagram illustrating an emission direction of a light beam from the distance measuring device according to an embodiment of the invention.

FIG. 4 is a schematic diagram illustrating how the distance measuring device detects an obstacle according to an embodiment of the invention.

FIG. 5 is a schematic diagram illustrating how the distance measuring device detect multiple obstacles arranged in ladder-like manner according to an embodiment of the invention.

FIG. 6 is a schematic diagram illustrating how the scanning unit of the distance measuring device rotates according to an embodiment of the invention.

FIG. 7 is a schematic diagram illustrating locations of the obstacles within the space as recorded by the distance measuring device according to an embodiment of the invention.

FIG. 8 is a flowchart illustrating a distance measuring method applied to the distance measuring device according to an embodiment of the invention.

### DESCRIPTION OF THE EMBODIMENTS

Descriptions of the invention are given with reference to the exemplary embodiments illustrated with accompanied drawings, in which same or similar parts are denoted with same reference numerals. In addition, whenever possible, identical or similar reference numbers stand for identical or similar elements in the figures and the embodiments.

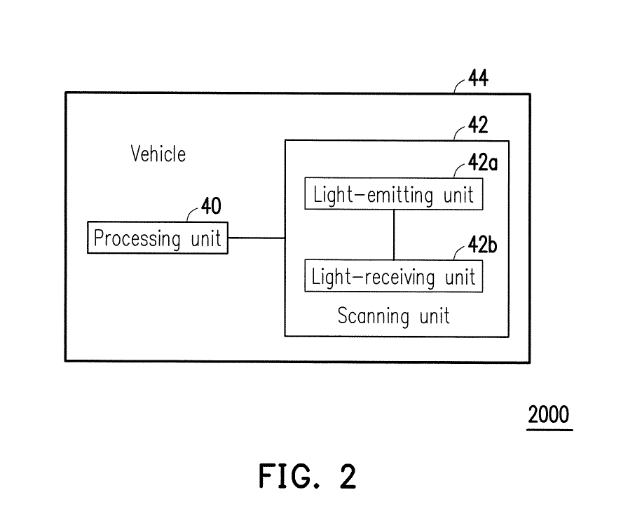

FIG. 2 is a block diagram illustrating a distance measuring device according to an embodiment of the invention. Referring to FIG. 2, a distance measuring device 2000 is, for example, a cleaning robot used for executing cleaning operations. The distance measuring device 2000 includes a processing unit 40, a scanning unit 42 and a vehicle 44. The processing unit 40 and the scanning unit 42 are separately disposed on the vehicle 44, and the processing unit 40 is electrically coupled to the scanning unit 42.

The processing unit 40 may be, for example, a processor for general purposes, a processor for special purposes, a conventional processor, a data signal processor, a plurality of microprocessors, one or more microprocessors, controllers, microcontrollers and Application Specific Integrated Circuit (ASIC) which are combined to a core of the digital signal processor, a Field Programmable Gate Array (FPGA), any other integrated circuits, a state machine, a processor based on Advanced RISC Machine (ARM) and similar products.

The scanning unit 42 includes a light-emitting unit 42a and a light-receiving unit 42b. The light-emitting unit 42a is electrically coupled to the light-receiving unit 42b. The light-emitting unit 42a is configured to provide a light source output required by the scanning unit 42. The light-emitting unit 42a can emit a light beam along an emission direction. In the present embodiment, the light-emitting unit 42a may be elements capable of emitting the light beam, such as a laser diode (LD) or a light emitting diode (LED). The light-receiving unit 42b may be elements capable of receiving light, such as a photoresistor, a phototransistor or a Photo-Detector diode.

The vehicle 44 can include a motion control unit (not illustrated) and a cleaning unit (not illustrated). Each of the motion control unit and the cleaning unit may be electrically coupled to the processing unit 40. The motion control unit may be configured to receive, for example, a control signal sent by the processing unit 40 and control the vehicle 44 to move on a plane based on the control signal. The motion control unit is composed of, for example, a plurality of hardware chips and further includes a motor (not illustrated) and a control equipment (not illustrated). Among them, the motor of the motion control unit may be coupled to tires (not illustrated) and the control equipment. After receiving the control signal from the control equipment, the motor can control rotation of the tires so as to control movement of the vehicle 44 on the plane. In addition, the cleaning unit may be a device for executing corresponding cleaning operations (e.g., vacuuming, sweeping or mopping) after receiving the control signal sent by the processing unit 40.

It should be understood that, elements included by distance measuring device 2000 are not limited only to be the elements illustrated in FIG. 2. Persons skilled in the art should understand that the distance measuring device 2000 may also include many other common elements.

In the present exemplary embodiment, the light-emitting unit 42a emits a light beam along an emission direction, where the emission direction of the light beam is not parallel to the plane where the vehicle 44 of the distance measuring device 2000 is located.

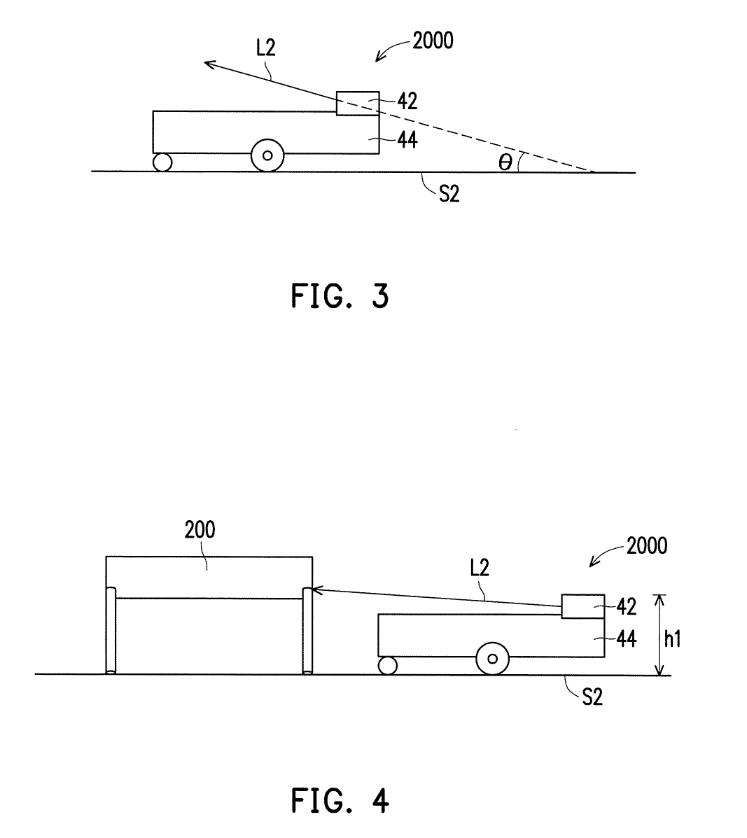

For instance, FIG. 3 is a schematic diagram illustrating an emission direction of a light beam from the distance measuring device according to an embodiment of the invention. Referring to FIG. 3, in the present exemplary embodiment, it is assumed that the distance measuring device 2000 moves on a plane S2 through the vehicle 44. The scanning unit 42 of the distance measuring device 2000 is disposed on a top end of the vehicle 44, and the emission direction of the light beam from the light-emitting unit 42a of the scanning unit 42 is adjusted to a rising state such that the light-emitting unit 42a can emit a light beam L2 along the emission direction that is not parallel to the plane S2. At the time, an acute angle included by the plane S2 where the vehicle 44 is located and the emission direction of the light beam L2 (or an extension of the emission direction of the light beam L2) is an angle θ. In the present exemplary embodiment, a value of the angle θ is greater than 0° and less than 90°. In other words, the value of the angle θ falls between 0° and 90° . In an exemplary embodiment, the angle θ may be 1°. However, the value of the angle θ is not particularly limited in the invention. Particularly, in an exemplary embodiment, the processing unit 40 of the distance measuring device 2000 may also send a control signal for adjusting the value of the angle θ. For example, the processing unit 40 of the distance measuring device 2000 can send a control signal for adjusting a rising degree of the light-emitting unit 42a so as to adjust the angle θ from a first angle into a second angle, where the first angle is different from the second angle.

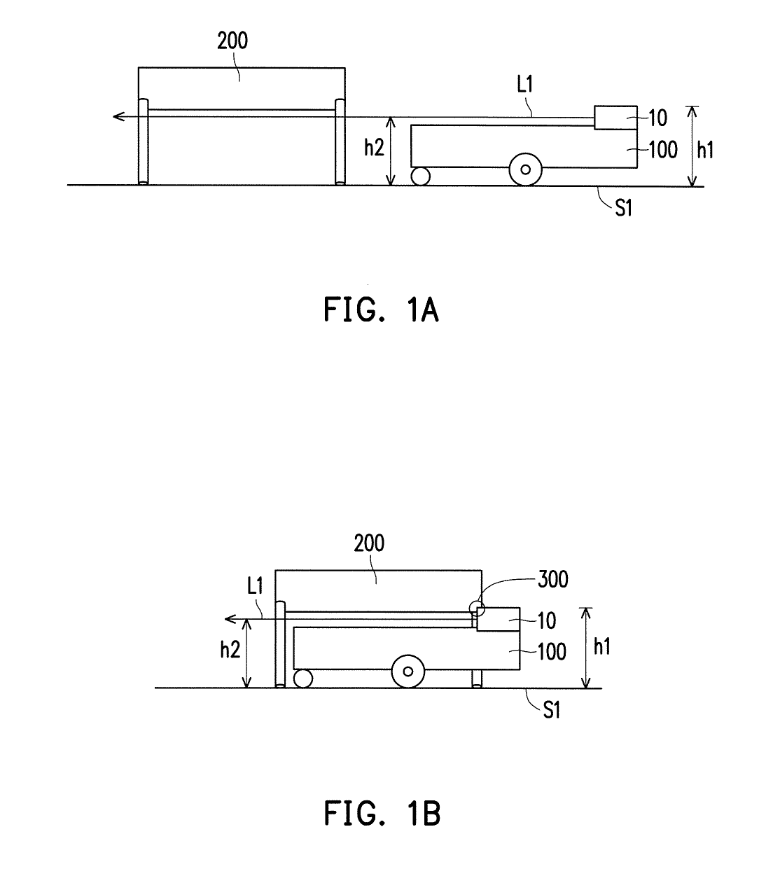

In particular, with the configuration described above, the distance measuring device 2000 may be prevented from the situation where the scanning unit collides with the obstacle as described in FIG. 1A and FIG. 1B. Specifically, FIG. 4 is a schematic diagram illustrating how the distance measuring device detects an obstacle according to an embodiment of the invention. Referring to FIG. 4, in the present embodiment, because the emission direction of the light beam L2 emitted by the light-emitting unit 42a of the scanning unit 42 is not parallel to the plane S2, the light-receiving unit 42b of the scanning unit 40 can receive a reflective light of the light beam L2 reflected by the obstacle with higher height (e.g., the bottom of the cushion of the chair 200). As such, the processing unit 40 of the distance measuring device 2000 can determine that the obstacle is in font of the distance measuring device 2000 and can determine a horizontal distance between the vehicle 44 and the chair 200 according to the reflective light. In addition, the processing unit 40 can further determine a vertical height from the plane S2 to a reflective spot of the light beam L2 on the chair 200 according to the received reflective light. In the exemplary embodiment of FIG. 4, because the processing unit 40 can determine that the height from the plane S2 to the bottom of the cushion of the chair 200 is less than or equal to the height from the plane S2 to a top end of the scanning unit 42 according to the received reflective light, the distance measuring device 2000 can then determine not to try passing through under the chair 200 but to go around avoiding the chair 200. Accordingly, the scanning unit 42 of the distance measuring device 2000 can be prevented from collision with the chair 200.

In addition, how to calculate the vertical height from the plane S2 to the reflective spot of the light beam L2 on the obstacle according to the reflective light and calculate the horizontal distance between the vehicle 44 and the obstacle according to the reflective light may be learnt with use the conventional art, and thus details regarding the same are omitted hereinafter.

In particular, the distance measuring device 2000 of the invention can further detect multiple obstacles arranged in ladder-like manner. For example, FIG. 5 is a schematic diagram illustrating how the distance measuring device detects multiple obstacles arranged in ladder-like manner according to an embodiment of the invention. With reference to FIG. 5, it is assumed that an obstacle 500 and an obstacle 501 are arranged side by side and placed on the plane S2. It is also assumed that, a distance from the plane S2 to a top end of the obstacle 500 is a height h3, and a distance from the plane S2 to a top end of the obstacle 501 is a height h4. When the distance measuring device 2000 is farther away from both the obstacle 500 and the obstacle 501, because the emission direction of the light beam from the light-emitting unit 42a of the scanning unit 42 is adjusted to a rising state such that the light-emitting unit 42a emits the light beam L2 in the emission direction that is not parallel to the plane S2, the distance measuring device 2000 can first detect the reflective light reflected by the obstacle 500 with higher height, so as to determine a distance between the vehicle 44 and the obstacle 500 and a height from the plane S2 to the reflective spot of the light beam L2 on the obstacle 500. When the distance measuring device 2000 moves in a forward direction 600, the distance measuring device 2000 can detect the reflective light reflected by the obstacle 501 with lower height, so as to determine a distance between the vehicle 44 and the obstacle 501 and a height from the plane S2 to the reflective spot of the light beam L2 on the obstacle 501. In this way, the distance measuring device 2000 of the invention is capable of detecting multiple obstacles arranged in ladder-like manner.

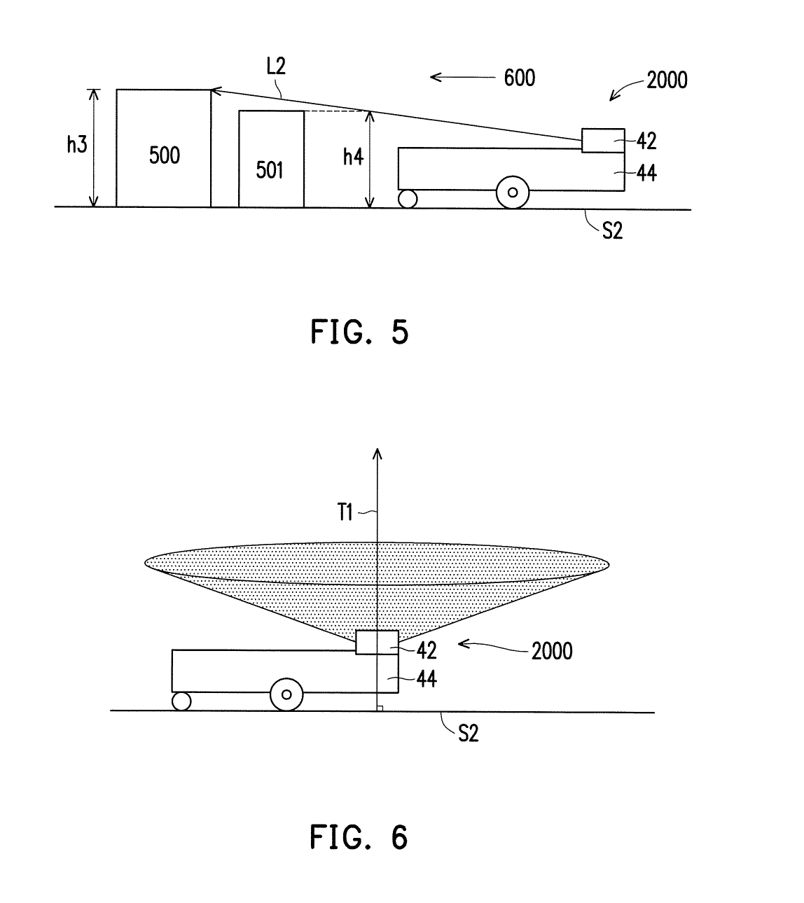

In an exemplary embodiment, the scanning unit 42 of the distance measuring device 2000 can also rotate to increase a detectable range of the scanning unit 42. FIG. 6 is a schematic diagram illustrating how the scanning unit of the distance measuring device rotates according to an embodiment of the invention. Referring to FIG. 6, the scanning unit 42 can rotate along a normal line T1 perpendicular to the plane S2. In the process of rotating the scanning unit 42, a region through which the light beam emitted the light-emitting unit 42a of the scanning unit 42 passes through shows a detection region in form of a conical surface, and the distance measuring device 2000 is able to detect the obstacle on the conical surface. In this way, the detectable range of the scanning unit 42 can then be increased.

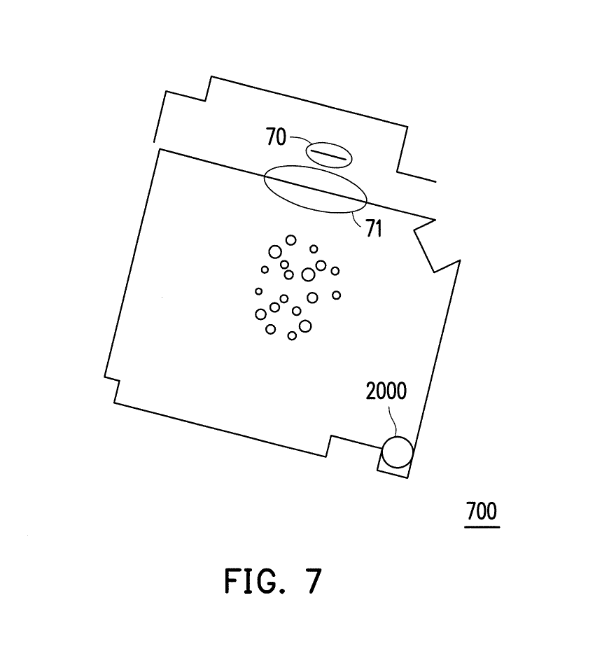

In an exemplary embodiment, the distance measuring device 2000 can also record locations of obstacles within a space according to a scanning result of the scanning unit 42. For example, FIG. 7 is a schematic diagram illustrating locations of the obstacles within the space as recorded by the distance measuring device according to an embodiment of the invention. Referring to FIG. 7, the distance measuring device 2000 can, for example, move within a space. The distance measuring device 2000 can scan the space by ways of the embodiments described above and generate an obstacle location distribution map 700 for the space. In the obstacle location distribution map 700 of FIG. 7, solid lines indicate regions where the distance measuring device 2000 is unable to pass through. Particularly, in the obstacle location distribution map 700, a line segment 70 and a line segment 71 are, for example, the two obstacles arranged in ladder-like manner as shown in FIG. 5. The distance measuring device 2000 can record the detected obstacle 500 with higher height as the line segment 70 and then record the subsequently detected obstacle 501 with lower height as the line segment 71. With the generated obstacle location distribution map 700, users or the distance measuring device 2000 can have better understanding of the distribution of the obstacles within the space.

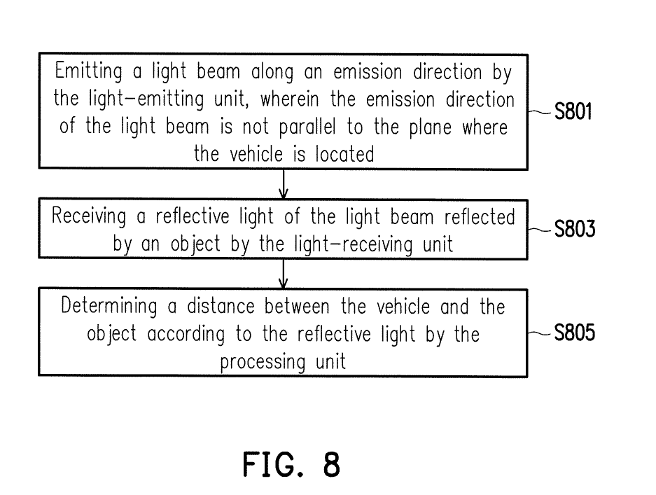

FIG. 8 is a flowchart illustrating a distance measuring method applied to the distance measuring device according to an embodiment of the invention.

Referring to FIG. 8, in step S801, the light-emitting unit 42a emits a light beam along an emission direction, where the emission direction of the light beam is not parallel to the plane S2 where the vehicle 44 is located. In step S803, the light-receiving unit 42b receives a reflective light of the light beam reflected by an object. Lastly, in step S805, the processing unit 40 determines a distance between the vehicle 44 and the object according to the reflective light.

In summary, by adjusting the emission direction of the light beam emitted by the scanning unit, the distance measuring device of the invention can effectively detect the obstacle and prevent the distance measuring device from collusion with the obstacle. In particular, instead of using a three-dimensional scanning unit in high price, the distance measuring device of the invention can scan the vertical height of the obstacle within the space by using common scanning units in low price, so as to achieve the similar effect of the three-dimensional scanning unit for detecting the height of the obstacle.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A distance measuring device, comprising:
a vehicle, configured to move on a plane;
a scanning unit, disposed on the vehicle, the scanning unit comprising:
a light-emitting unit, configured to emit a light beam along an emission direction, wherein the emission direction of the light beam is not parallel to the plane; and
a light-receiving unit, configured to receive a reflective light of the light beam reflected by an object; and
a processing unit, disposed on the vehicle, electrically coupled to the scanning unit, and configured to determine a distance between the vehicle and the object according to the reflective light.

2. The distance measuring device according to claim 1, wherein an acute angle included by the plane and the emission direction is greater than 0° and less than 90°.

3. The distance measuring device according to claim 2, wherein the acute angle included by the plane and the emission direction is 1°.

4. The distance measuring device according to claim , wherein
the processing unit is further configured to determine a vertical height between a reflective spot on the object and the plane according to the reflective light, wherein the light beam is reflected at the reflective spot to generate the reflective light.

5. The distance measuring device according to claim 1, wherein
the processing unit is further configured to send a control signal for adjusting an angle of the acute angle included by the plane and the emission direction.

6. The distance measuring device according to claim 1, wherein
the scanning unit is configured to rotate along a normal line of the plane.

7. A distance measuring method for a distance measuring device, the distance measuring device having a vehicle, a scanning unit and a processing unit, the scanning unit comprising a light-emitting unit and a light-receiving unit, the scanning unit and the processing unit being disposed on the vehicle, the vehicle being configured to move on a plane, the distance measuring method comprising:
emitting a light beam along an emission direction by the light-emitting unit, wherein the emission direction of the light beam is not parallel to the plane;
receiving a reflective light of the light beam reflected by an object by the light-receiving unit; and
determining a distance between the vehicle and the object according to the reflective light by the processing unit.

8. The distance measuring method according to claim 7, wherein an acute angle included by the plane and the emission direction is greater than 0° and less than 90°.

9. The distance measuring method according to claim 8, wherein the acute angle included by the plane and the emission direction is 1°.

10. The distance measuring method according to claim 7, further comprising:
determining a vertical height between a reflective spot on the object and the plane according to the reflective light by the processing unit, wherein the light beam is reflected at the reflective spot to generate the reflective light.

11. The distance measuring method according to claim 7, further comprising:
sending a control signal by the processing unit to adjust an angle of the acute angle included by the plane and the emission direction.

12. The distance measuring method according to claim 7, further comprising:
rotating the scanning unit along a normal line of the plane.
